(19) United States
(12) Patent Application Publication
(10) Pub. No.: US 2009/0237363 A1
(43) Pub. Date: Sep. 24, 2009

(54) PLURAL TEMPORALLY OVERLAPPING DRAG AND DROP OPERATIONS

(75) Inventors: Robert Levy, Seattle, WA (US); Sundaram Ramani, Redmond, WA (US); Maxim Mazeev, Redmond, WA (US); Kevin Kennedy, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/052,714

(22) Filed: Mar. 20, 2008

(51) Int. Cl. G06F 3/041

(52) U.S. Cl. 345/173

(57) ABSTRACT

Plural temporally overlapping drag and drop operations are performed by binding a first source to a first input and identifying a potential target of the first source. During a duration in which the first source remains bound to the first input, a second operation is initiated as a second source is bound to a second input and a potential target of the second source is identified. While both the first and second sources are bound to respective inputs, a request from the potential target of the first source is received to claim the first source and the first source is released to the potential target of the first source, completing the first operation. The second operation is completed as a request from the potential target of the second source is received to claim the second source and the second source is released to the potential target of the second source.

### BACKGROUND

Computing systems can be designed to help computing users perform a virtually unlimited number of different computing tasks. A user can be overwhelmed with the vast capabilities of a computing system, and in particular, of the many commands that the user may need to learn in order for the user to cause the computing system to perform the desired tasks. As such, some computing systems are designed with graphical user interfaces that may lower the command-learning barrier. The graphical user interfaces can provide users with intuitive mechanisms for interacting with the computing system. As a nonlimiting example, a drag and drop operation is an intuitive procedure that may be performed to manipulate and/or organize information, initiate executable routines, or otherwise facilitate a computing task via a graphical user interface. Without the drag and drop operation, such computing tasks may need to be initiated using less intuitive means, such as command line text input.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Plural temporally overlapping drag and drop operations can be performed by allowing different source objects to be bound to different inputs for overlapping durations. While each source is bound to its input, a potential target can be identified for that source, the target can claim the source, and the source can be released to the target. In this way, the drag and drop operation of a first source to a first target does not interfere or otherwise prevent the drag and drop operation of another source to the same or a different target.

### BRIEF DESCRIPTION OF THE DRAWINGS

FIG. 1 shows an example computing system on which plural temporally overlapping drag and drop operations may be performed.

FIG. 2 shows an example computing system on which plural temporally overlapping drag and drop operations may be performed via a plurality of touch inputs.

FIGS. 3-7 show examples of different types of temporally overlapping drag and drop operations.

FIGS. 8-9 show examples of different hit tests that may be performed during a drag and drop operation.

FIGS. 10-11 show examples of cursors that may be generated to visually track an input during a drag and drop operation.

FIG. 12 shows a process flow of an example method of performing plural temporally overlapping drag and drop operations.

### DETAILED DESCRIPTION

A drag and drop operation may be performed by an input in order to manipulate and/or organize information in an intuitive manner. A drag and drop operation may involve a display element selected by the input as a source of the drag and drop operation and a display element that serves as a target of the source of the drag and drop operation. Moreover, in a computing system including a plurality of inputs, temporally overlapping drag and drop operations may be performed with some or all of the plurality of inputs. The present disclosure is directed to an approach for performing temporally overlapping drag and drop operations of display elements on a display of a computing system.

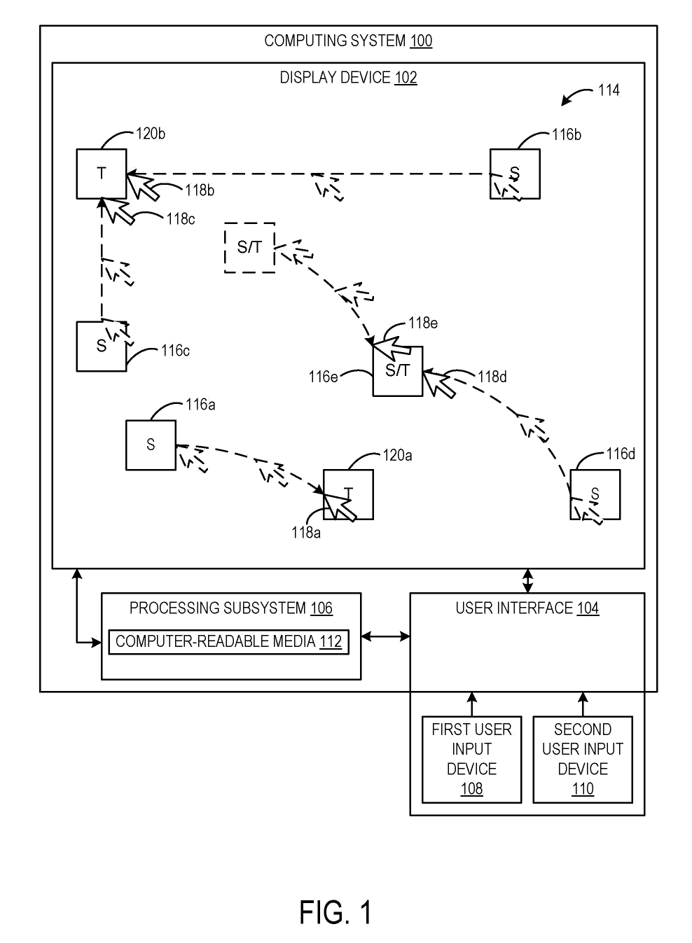

FIG. 1 shows a nonlimiting example of a computing system 100. Computing system 100 may include a display device 102, a user interface 104, and a processing subsystem 106.

Display device 102 may be configured to present a plurality of display elements 114. Each of the display elements may be representative of various computing objects such as files, folders, application programs, etc. The display elements may be involved in drag and drop operations to manipulate and/or organize the display elements, initiate executable routines, or otherwise facilitate a computing function.

Display device 102 may include any suitable technology to present information for visual reception. For example, display device 102 may include an image-producing element such as a LCD (liquid crystal display), a LCOS (liquid crystal on silicon) display, a DLP (digital light processing) display, or any other suitable image-producing element. Further, display device 102 may include a light source, such as for example, a lamp or LED (light emitting diode) to provide light to the image-producing element in order to display a projected image.

Display device 102 may be orientated in virtually any suitable orientation to present information for visual reception. For example, the display device may be orientated substantially vertically. In one particular example, the computing system may be a multi-touch surface computing system and the display device may have a substantially horizontal orientation. While the display device is shown as being substantially planar, non-planar displays are also within the scope of this disclosure. Further, the size of the display device may be varied while remaining within the scope of this disclosure.

User interface 104 may be configured to receive one or more types of input. For example, the user interface may receive input that includes peripheral input that may be generated from a peripheral input device of the user interface, such as a mouse, a keyboard, etc. As another example, the user interface may receive input that includes touch input that may be generated from contact of an object, such as a finger of a user, a stylus, etc. In one particular example, a user interface may include a display device configured to receive touch input.

Furthermore, the user interface may be configured to receive multiple inputs. In the illustrated example, user interface 104 may receive a first input via a first user input device 108 and a second input via a second user input device 110. As another example, a user interface configured to receive touch input may receive a first input from a first finger of a first user and a second input from a second finger of a second user.

It will be appreciated that a plurality of input control providers (e.g., mouse, finger, etc.) each may control an input independent of other input providers. For example, a first one of a plurality of user input devices may control a first input independent of other of the plurality of user input devices, and a second one of the plurality of user input devices may control a second input independent of other of the plurality of user input devices.

It will be appreciated that the user interface may be configured to receive virtually any suitable number of inputs from virtually any number of input providers. Further, it will be appreciated that the user interface may be configured to receive a combination of peripheral inputs and touch inputs.

Processing subsystem 106 may be operatively connected to display device 102 and user interface 104. Input data received by the user interface may be passed to the processing subsystem and may be processed by the processing subsystem to effectuate changes in presentation of the display device. Processing subsystem 106 may be operatively coupled to computer-readable media 112. The computer-readable media may be local or remote to the computing system, and may include volatile or non-volatile memory of any suitable type. Further, the computer-readable media may be fixed or removable relative to the computing system.

The computer-readable media may store or temporarily hold instructions that may be executed by processing subsystem 106. Such instructions may include system and application instructions. It will be appreciated that in some embodiments, the processing subsystem and computer-readable media may be remotely located from the computing system. As one example, the computer-readable media and/or processing subsystem may communicate with the computing system via a local area network, a wide area network, or other suitable communicative coupling, via wired or wireless communication.

The processing subsystem may execute instructions that cause plural temporally overlapping drag and drop operations to be performed. As such, each of a plurality of inputs may perform temporally overlapping drag and drop operations with different display elements. The display elements involved in drag and drop operations each may include properties that characterize the display elements as a source of a drag and drop operation, a target of a drag and drop operation, or both a source and a target of different drag and drop operations. Further, it will be appreciated that a display element may have properties that exclude the display element from being involved in a drag and drop operation.

During a drag and drop operation, a source may be moved by an input to a target. It will be appreciated that a target may be located at virtually any position on a display and the source may be moved by the input to virtually any desired position on the display. Further, in some cases, a source may be moved to multiple different positions on a display by an input before being moved to a target.

Continuing with FIG. 1, several examples of different types of temporally overlapping drag and drop operations are presented by display device 102. In the example drag and drop operations described herein, each of the multiple different inputs are represented with arrow cursors to track the movement of the different inputs. The dashed lines track paths of the cursor, source and/or the target during the drag and drop operation. It will be appreciated that the position and/or orientation of a cursor may change as the cursor tracks movement of an input and the changes in position and/or orientation of a cursor may reflect changes in position and/or orientation of an input.

In a first example type of drag and drop operation, a first source 116a may be bound to a first input 118a. First input 118a may move to a first target 120a and may release first source 116a to first target 120a to complete the drag and drop operation. In this example, a single source is dragged and dropped to a single target. In a second example type of drag and drop operation, a second source 116b may be bound to a second input 118b and a third source 116c may be bound to a third input 118c. Second input 118b may move to second target 120b and may release second source 116b to second target 120b. Likewise, third input 118c may move to second target 120b and may release third source 116c to second target 120b. In this example, the potential target of the second source is the potential target of the third source. In other words, two sources are dragged and dropped to the same target by different temporally overlapping inputs.

In a third example type of drag and drop operation, a fourth source 116d may be bound to a fourth input 118d and a fifth source 116e may be bound to a fifth input 118e. However, the fifth source may be both a target and a source. In this example, the fifth source is the potential target of the fourth source. Fifth input 118e may be moving fifth source 116e and fourth input 118d may move to fifth source 116e (and target) and may release fourth source 116d to fifth source 116e. The above drag and drop operations are merely examples and other temporally overlapping drag and drop operations may be performed.

Although the above described examples are discussed in the context of plural temporally overlapping drag and drop operations, it will be appreciated that other types of computing operations may be performed during a temporally overlapping duration in which a drag and drop operation is performed. For example, upon initiation of a primary drag and drop operation, a secondary independent computing operation may be initiated without interrupting the primary drag and drop operation. Nonlimiting examples of a secondary independent computing operation may include, scrolling through a list, pressing buttons on a touch screen, entering text on a keyboard, etc. Such secondary inputs can be initiated while the primary drag and drop operation is in process, or vice versa.

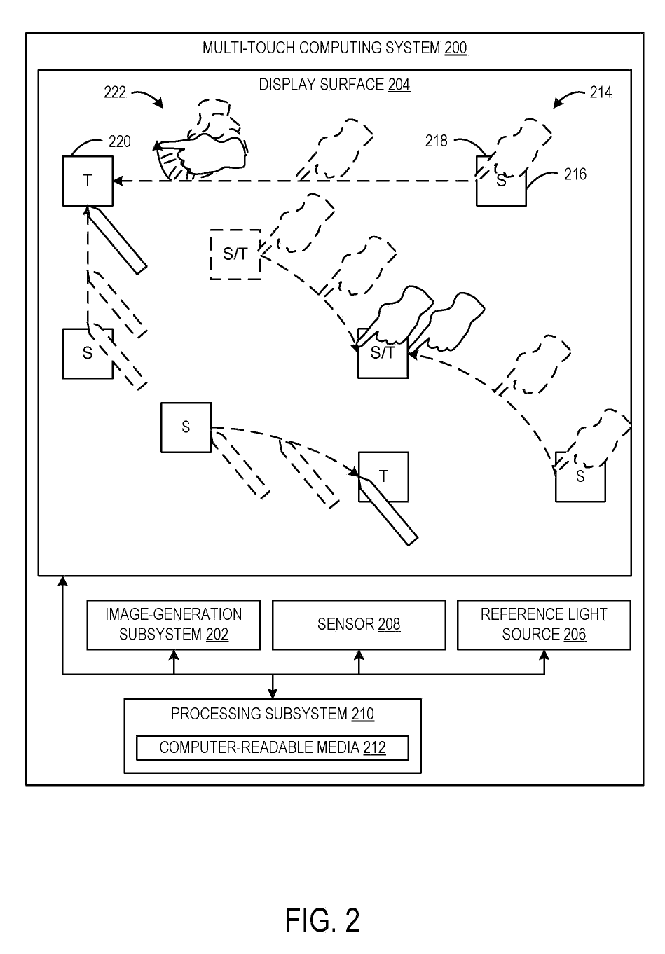

FIG. 2 shows an example of a multi-touch computing system on which plural temporally overlapping drag and drop operations may be performed via touch inputs. Multi-touch computing system 200 may include an image-generation subsystem 202 positioned to project images on display surface 204, a reference light source 206 positioned to direct reference light at display surface 204 so that a pattern of reflection of the reference light changes responsive to touch input on display surface 204, a sensor 208 to detect the pattern of reflection, a processing subsystem 210 operatively connected to image-generation subsystem 202 and sensor 208, and computer-readable media 212 operatively connected to processing subsystem 210.

Image-generation subsystem 202 may be in operative connection with a reference light source 206, such as a lamp that may be positioned to direct light at display surface 204. In other embodiments, reference light source 206 may be configured as an LED array, or other suitable light source. Image-generation subsystem 202 may also include an image-producing element such as a LCD (liquid crystal display), a LCOS (liquid crystal on silicon) display, a DLP (digital light processing) display, or any other suitable image-producing element.

Display surface 204 may be any suitable material for presenting imagery projected on to the surface from image-generation subsystem 202. Display surface 204 may include a clear, transparent portion, such as a sheet of glass, and a diffuser screen layer disposed on top of the clear, transparent portion. In some embodiments, an additional transparent layer may be disposed over the diffuser screen layer to provide a smooth look and feel to the display surface. As another nonlimiting example, display surface 204 may be a light-transmissive rear projection screen capable of presenting images projected from behind the surface.

Reference light source 206 may be positioned to direct light at display surface 204 so that a pattern of reflection of reference light emitted by reference light source 206 may change responsive to touch input on display surface 204. For example, light emitted by reference light source 206 may be reflected by a finger or other object used to apply touch input to display surface 204. The use of infrared LEDs as opposed to visible LEDs may help to avoid washing out the appearance of projected images on display surface 204.

In some embodiments, reference light source 206 may be configured as multiple LEDs that are placed along a side of display surface 204. In this location, light from the LEDs can travel through display surface 204 via internal reflection, while some light can escape from display surface 204 for reflection by an object on the display surface 204. In alternative embodiments, one or more LEDs may be placed beneath display surface 204 so as to pass emitted light through display surface 204.

Sensor 208 may be configured to sense objects providing touch input to display surface 204. Sensor 208 may be configured to capture an image of the entire backside of display surface 204. Additionally, to help ensure that only objects that are touching display surface 204 are detected by sensor 208, a diffuser screen layer may help to avoid the imaging of objects that are not in contact with or positioned within a few millimeters of display surface 204.

Sensor 208 can be configured to detect the pattern of reflection of reference light emitted from reference light source 206. The sensor may include any suitable image sensing mechanism. Nonlimiting examples of suitable image sensing mechanisms include, but are not limited to, CCD and CMOS image sensors. Further, the image sensing mechanisms may capture images of display surface 204 at a sufficient frequency to detect motion of an object across display surface 204.

Sensor 208 may be configured to detect multiple touch inputs. Sensor 208 may also be configured to detect reflected or emitted energy of any suitable wavelength, including but not limited to infrared and visible wavelengths. To assist in detecting touch input received by display surface 204, sensor 208 may further include an additional reference light source 206 (i.e. an emitter such as one or more light emitting diodes (LEDs)) positioned to direct reference infrared or visible light at display surface 204.

Processing subsystem 210 may be operatively connected to image-generation subsystem 202 and sensor 208. Processing subsystem 210 may receive signal data from sensor 208 representative of the pattern of reflection of the reference light at display surface 204. Correspondingly, processing subsystem 210, may process signal data received from sensor 208 and send commands to image-generation subsystem 202 in response to the signal data received from sensor 208. Furthermore, display surface 204 may alternatively or further include an optional capacitive, resistive, or other electromagnetic touch-sensing mechanism.

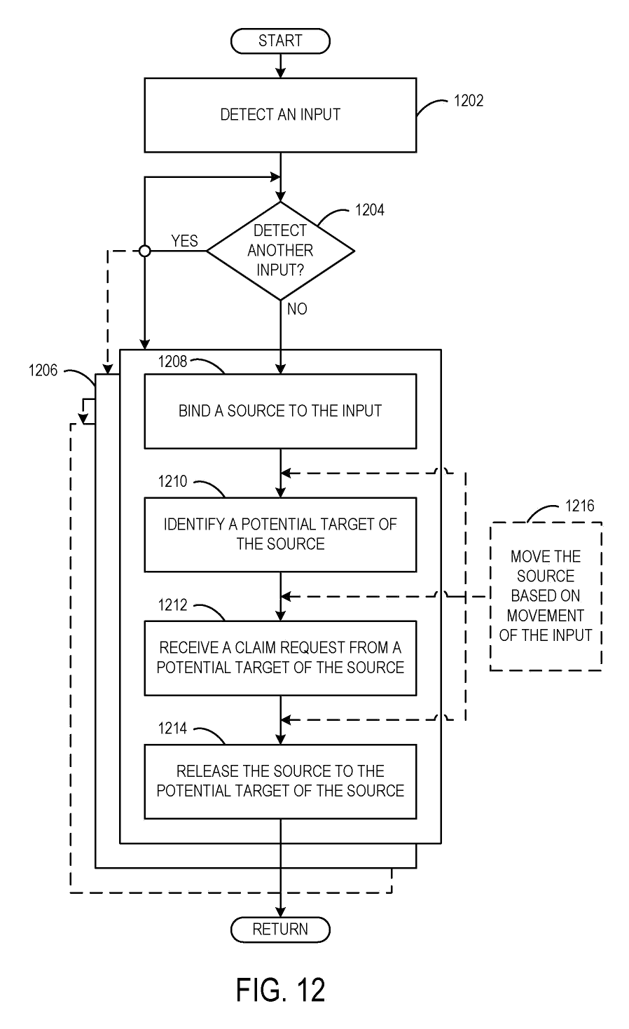

Computer-readable media 212 may be operatively connected to processing subsystem 210. Processing subsystem 210 may execute instructions stored on the computer-readable media that cause plural temporally overlapping drag and drop operations to be performed as described below with reference to FIG. 12.

Continuing with FIG. 2, multiple objects generating different touch inputs are shown performing different types of temporally overlapping drag and drop operations. In the depicted examples, a drag and drop operation may be initiated when an object contacts the display surface at or near a source resulting in the source being bound to a touch input of the object. It will be appreciated that virtually any suitable object may be used to generate a touch input on the display surface of the multi-touch computing system. For example, a touch input may be generated from a finger of a user. As another example, a stylus may be used to generate a touch input on the display surface. Further, virtually any suitable number of different touch inputs may be detected on the display surface by the multi-touch computing system.

In some embodiments, upon initiation of a drag and drop operation by a touch input, a cursor may be generated to track movement of the touch input. The position and/or orientation of the cursor may change as the cursor tracks movement of the touch input and the changes in position and/or orientation of the cursor may reflect changes in position and/or orientation of the touch input. In some cases, the cursor may be visually representative of the source bound to the touch input.

In some embodiments, the multi-touch computing system may include a computer based training system to educate the user on how to perform drag and drop operations via touch input. For example, the computer based training system may be configured to present an image of a hand on the display surface which may perform a drag and drop operation, such as dragging a photograph off a stack of photographs to a photo album.

The different types of drag and drop operations depicted in FIG. 2 are similar to those described with reference to FIG. 1. However, an additional example of a type of drag and drop operation that is particularly applicable to a touch input computing system is shown at 214 and is described herein. In this example, the drag and drop operation is initiated by a finger of a user creating a touch input 218 by contacting display surface 204 at a source 216 causing source 216 to be bound to touch input 218. The drag and drop operation continues with touch input 218 moving source 216 in the direction of a target 220. At 222, the finger of the user may perform an action that may be referred to as a “flick.” Specifically, the finger of the user may move toward target 220 but the finger may be lifted from display surface 204 before reaching target 220. The particular pattern of reflected light generated by the flick may be recognized by sensor 208 and/or processing subsystem 210, and processing subsystem 210 may send commands to image-generation subsystem 202 to display source 216 moving with a velocity generated from the flick action as determined by the processing subsystem 210. Due to the velocity of source 216 generated from the flick action, source 216 may reach target 220 to complete the drag and drop operation.

It will be appreciated that a drag and drop operation may or may not be completed based on the amount of velocity generated by the flick, the distance from the source to the target, and/or one or more other factors. In other words, if the flick action is small, not enough velocity may be generated to move the source to the target to complete the drag and drop operation. It will be appreciated that other objects used to generate a touch input may be capable of performing a flick action to complete a drag and drop operation. Although the flick action is described in the context of touch input, it will be appreciated that a flick action need not be performed via touch input. For example, a mouse or other user input device may perform a flick action to complete a drag and drop operation. Further, the computing system may be configured to perform plural temporally overlapping drag and drop operations involving flick actions.

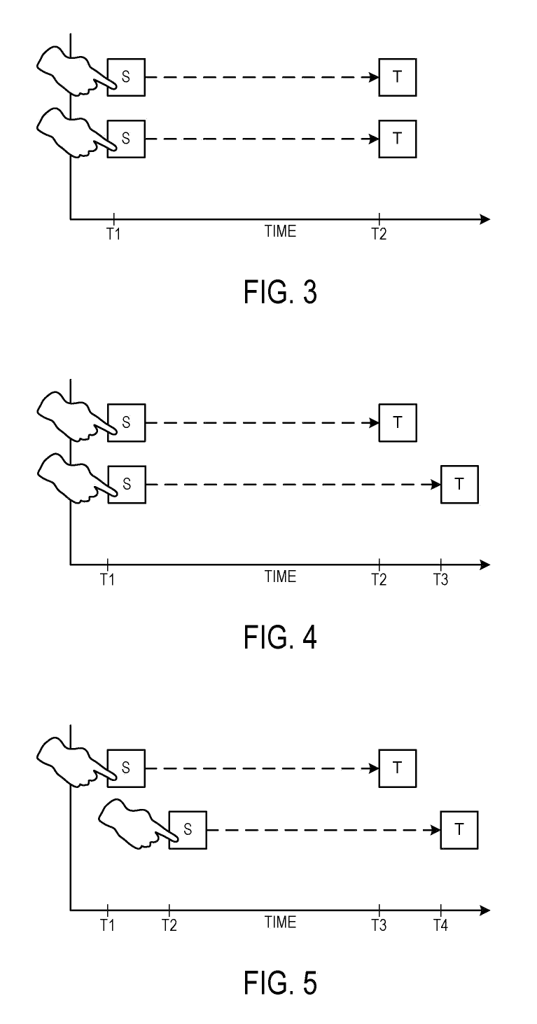

FIGS. 3-7 show examples of plural drag and drop operations performed during different temporally overlapping durations. FIG. 3 shows a first example of plural drag and drop operations performed during a temporally overlapping duration where the two drag and drop operations are performed during the same duration. In particular, a first drag and drop operation is initiated at time T1 and is concluded at time T2. A second drag and drop operation is also initiated at time T1 and is also concluded at time T2. In this example, the temporally overlapping duration is from time T1 to time T2.

FIG. 4 shows a second example of plural drag and drop operations performed during a temporally overlapping duration where two drag and drop operations are initiated at the same time and are concluded at different times. In particular, a first drag and drop operation is initiated at time T1 and is concluded at time T2. A second drag and drop operation is also initiated at the same time T1 but concludes at a different time T3. In this example, the temporally overlapping duration is from time T1 to time T2.

FIG. 5 shows a third example of plural drag and drop operations performed during a temporally overlapping duration where two drag and drop operations are initiated at different times and are concluded at different times. In particular, a first drag and drop operation is initiated at time T1 and is concluded at time T3. A second drag and drop operation is initiated at time T2 and is concluded at time T4. In this example, the overlapping duration is from time T2 to time T3. Further, in this example, the first drag and drop operation and the second drag and drop operation may or may not have durations of equal length, but the durations may be time shifted.

FIG. 6 shows a fourth example of plural drag and drop operations performed during a temporally overlapping duration where two drag and drop operations are initiated at different times and are concluded at different times. In particular, a first drag and drop operation is initiated at time T1 and is concluded at time T4. A second drag and drop operation is initiated at time T2 and is concluded at time T3. In this example, the overlapping duration is from time T2 to time T3.

FIG. 7 shows a fifth example of plural drag and drop operations performed during a temporally overlapping duration where two drag and drop operations are initiated at different times and are concluded at the same time. In particular, a first drag and drop operation is initiated at time T1 and is concluded at time T3. A second drag and drop operation is initiated at time T2 and is concluded at time T3. In this example, the overlapping duration is from time T2 to time T3.

Although the above described examples are discussed in the context of plural temporally overlapping drag and drop operations, it will be appreciated that other types of computing operations may be performed during a temporally overlapping duration in which a drag and drop operation is performed without interrupting the drag and drop operation.

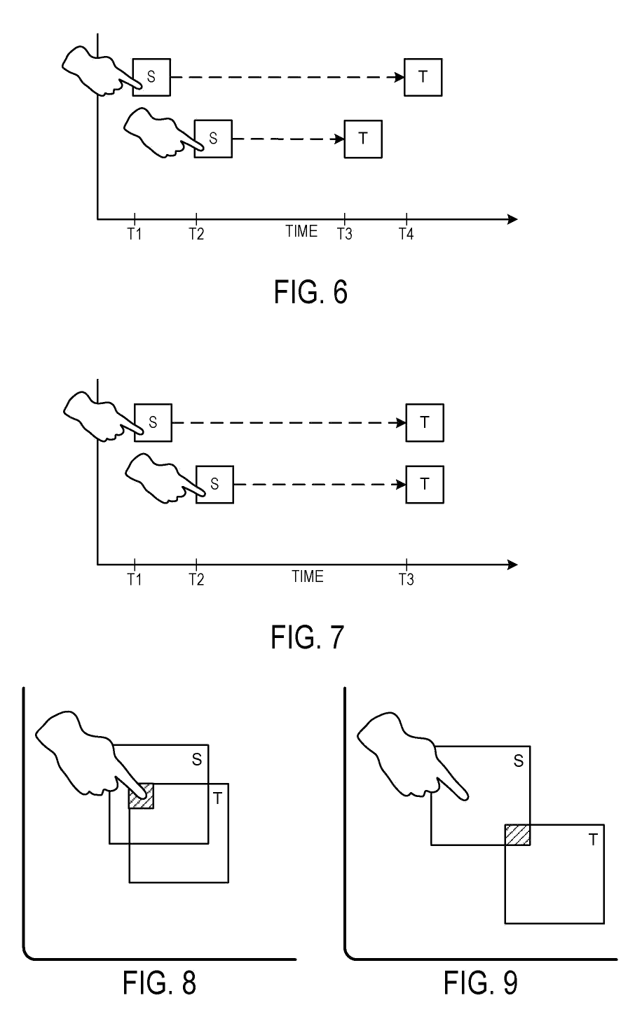

In some examples, during a drag and drop operation, a target may request to claim a source bound to an input based on being involved in a hit test. FIGS. 8-9 show examples of different types of hit tests that may be performed involving a target with an input and/or a source. In the examples described herein, the depicted input is a touch input represented by a finger of a hand. Further, an intersection of an object (either a touch input or a source) with a target involved in a hit test is represented by diagonal hash marks. In some embodiments, a source and/or a target may change appearance (e.g., become highlighted) to indicate that objects are intersecting.

FIG. 8 shows an example hit test where intersection of an input to which a source is bound and a potential target of the source results in a successful hit test. In some examples, based on this type of hit test, a source may not be claimed by and/or released to a target until the input intersects with the target involved in the hit test.

FIG. 9 shows an example hit test where intersection of a bound source and a potential target of the bound source results in a successful hit test. In some examples, based on this type of hit test, a source may not be claimed by and/or released to a target until the bound source intersects with the target involved in the hit test.

It will be appreciated that the above described hit tests are merely examples and that other suitable types of hit testing may be performed during a drag and drop operation. Further, some types of hit tests may have optional or additional testing parameters, such as temporal, geometric, source/target properties, etc. In some embodiments, hit testing may be performed at a source, at a target and/or at an input.

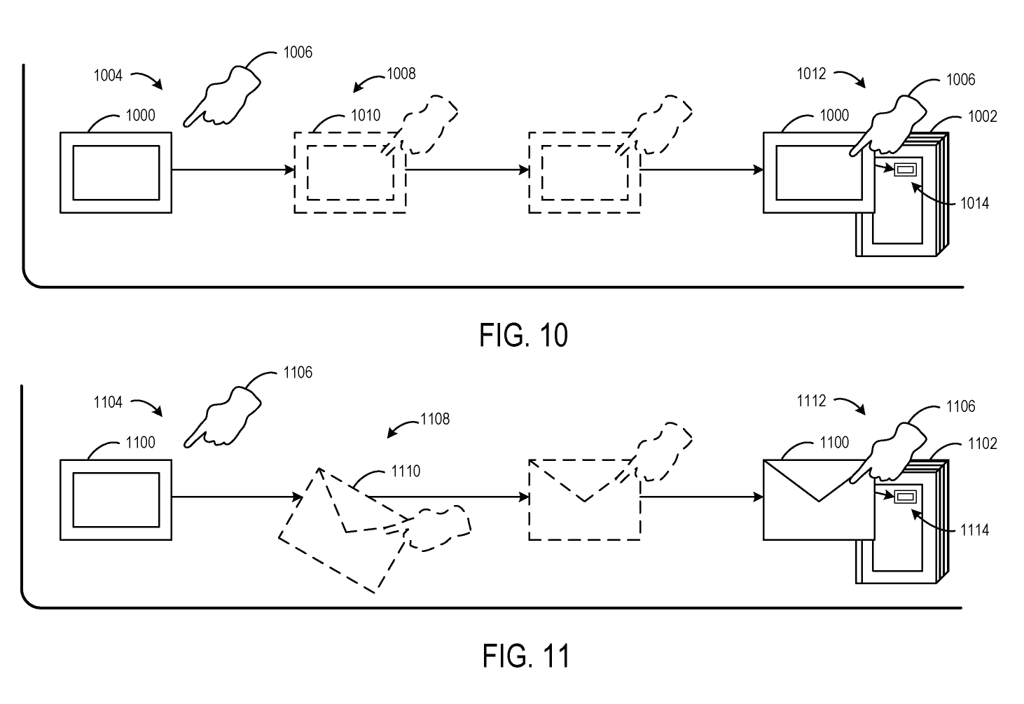

In some embodiments, a cursor may be displayed that tracks an input during a drag and drop operation. FIGS. 10-11 show examples of different cursors that may be generated to track an input during a drag and drop operation. In these examples, the sources are depicted as a photograph 1000 and a photograph 1100 that is dragged and dropped to respective targets depicted as a photo album 1002 and a photo album 1102.

FIG. 10 shows, at 1004, photograph 1000 just prior to being bound to an input 1006. At 1008, the photograph may be bound to input 1006, and a cursor 1010 may be generated to track input 1006 throughout the drag and drop operation. Since the cursor tracks the input, the position and/or orientation of the cursor may change based on changes in position and/or orientation of the input. In this example, the cursor may include a visual representation of the bound source (e.g., the photograph). By making the cursor visually representative of the source during the drag and drop operation, and making the cursor reflect the initial position and/or orientation of the source upon initiating the drag and drop operation, the transition into the drag and drop operation may be perceived as seamless and intuitive, especially in touch input applications.

At 1012, input 1006 has dragged photograph 1000 to photo album 1002. Upon release of the photograph to the photo album, an action may be performed to signify the conclusion of the drag and drop operation. For example, an animation of the photograph going into the photo album may be performed resulting in the photograph being displayed in the photo album at 1014. It will be appreciated that other suitable actions may be performed to signify the end of a drag and drop operation. In some cases, an action to signify the conclusion of a drag and drop operation may be omitted.

FIG. 11 shows, at 1104, photograph 1100 just prior to being bound to an input 1106. At 1108, the photograph may be bound to the input, and a cursor 1110 may be generated to track the input throughout the drag and drop operation. In particular, changes in position of the touch input may be reflected by changes in the position and/or orientation of the cursor. For example, at 1108, the touch input changes position and orientation (e.g., rotates hand clockwise and translates downward) and the cursor changes orientation to reflect the change of the touch input.

In this example, instead of the visual representation of the cursor being depicted as the bound source, the visual representation of the cursor is depicted as an envelope. The visual representation of the cursor may differ from that of the bound source in order to provide an indication that the source is involved in a drag and drop operation, and/or to indicate a subsequent result of the drag and drop operation (e.g., an uploading of the photograph to a remotely located photo album). Although the visual representation of the cursor is depicted as an envelope, it will be appreciated that the visual representation may be depicted as virtually any suitable image.

At 1112, input 1106 has dragged photograph 1100 to photo album 1102. Upon release of the photograph to the photo album, an action may be performed to signify the conclusion of the drag and drop operation. For example, an animation of the envelope opening and the photograph going into the photo album may be performed resulting in the photograph being displayed in the photo album at 1114.

FIG. 12 is a schematic depiction of an example process flow for performing plural temporally overlapping drag and drop operations. Beginning at 1202, the method may include detecting an input. As discussed above, an input may be detected via a user interface.

Next, at 1204, the method may include detecting another input. If another input is detected, the process flow may branch to 1206 and a second drag and drop (or other type of computing operation) process flow may temporally overlap with the first process flow as a source is bound to the other input. Furthermore, if additional inputs are detected, additional drag and drop (or other type of computing operation) process flows may be initiated for the additional inputs as sources are bound to the additional inputs. It will be appreciated that the temporally overlapping process flows may conclude based on completion of the additional drag and drop operations (or other type of independent computing operation). Further, it will be appreciated that a process flow may not be initiated for an additional input detected beyond the first input, if the additional input contacts a source that is bound to the first input.

At 1208, the method may include binding a source to the input. In some examples, binding a source to an input may cause a source to move and/or rotate based on movements of the input to which the source is bound, such that movements of the input cause the same movements of the bound source.

In some embodiments, the source may be bound to an input in response to an action (or signal) of a provider controlling the input. For example, a user input device may be used to control an input and a button of the user input device may be clicked to initiate binding of the source to the input. In another example, an action may include an object contacting a display surface at or near a source to create a touch input that initiates binding of the source to the touch input.

In some embodiments, the source may be bound to an input in response to the input moving a threshold distance after contacting the source. In some embodiments, the threshold distance may be a distance of virtually zero or no movement.

In some embodiments, the method may include displaying a cursor that tracks the input. In some examples, the input may be visually represented by the cursor and may visually change in response to a source binding to the input. For example, the cursor may include a visual representation of the source. Further, in some cases, the cursor may be displayed when the source is bound to the input.

In some embodiments, in the event that multiple inputs interact (e.g., intersect, contact, etc.) with a source, the first input to interact with the source may initiate a drag and drop operation and the source may be bound to the first input. Further, the source may be bound to the other inputs as they interact with the source. As the source is bound to an additional input, the position, orientation, and/or size of the cursor representing the source may be adjusted to reflect the aggregated position of all inputs to which the source is bound. If one of the inputs to which the source is bound is no longer detected, the drag and drop operation may continue under the control of the remaining inputs to which the source is bound. In some cases, the drag and drop operation may conclude based on the last bound input releasing the source.

Next, at 1210, the method may include identifying a potential target of the source. In one example, identifying a potential target may include identifying one or more possible targets based on a property of the one or more possible targets. Nonlimiting examples of properties of potential targets may include being designated as a folder of any type or a specified type, a specified application program, proximity to the source, etc.

In some embodiments, in response to a source being bound to an input, a notification may be sent out to one or more potential targets based on properties of the potential targets. Further, in some cases, upon receiving the notification, one or more potential targets may become highlighted or change appearance to indicate that the one or more potential targets is/are available. As another example, all potential targets may be identified based on properties of the potential targets. Further, a notification may be sent to all potential targets in response to a source being bound to an input.

Next, at 1212, the method may include receiving a claim request from a potential target of the source. In some embodiments, one or more potential targets may make claim requests in response to receiving notification of a source being bound to an input. In some embodiments, all potential targets may make claim requests in response to receiving notification of a source being bound to an input. In some embodiments, a potential target may make a request to claim a source in response to being involved in a successful hit test.

Next, at 1214, the method may include releasing the source to the potential target of the source. In some embodiments, the source may be released to a potential target based on a predetermined hierarchy. For example, a plurality of requests may be received to claim a source and the source may be released to a requesting target based on a predetermined hierarchy, which may be at least partially based on a distance between the source and the target. It will be appreciated that the hierarchy may be based on various other properties of the potential targets and/or the source. In some embodiments, a source may be released to a potential target in response to a successful hit test.

Furthermore, a source may be released to a target responsive to conclusion of input at the source. For example, in the case of a drag and drop operation performed via touch input, a touch input may move a bound source to a target, and the drag and drop operation may not conclude until conclusion of the touch input at the source. In other words, the drag and drop operation may conclude when a touch input object (e.g., a finger) is lifted from a surface of the touch display.

At 1216 the method may include moving the source based on movement of the input. The source may change position and/or orientation with each movement of the input. The source may be moved based on movement of the input at least at any time between the source being bound to the input and the source being released to the potential target of the source. It will be appreciated that the source may be moved based on movement of the input one or more times throughout the drag and drop operation.

By performing the above described method, plural temporally overlapping drag and drop operations may be performed by different inputs. In this way, the intuitiveness and efficiency of display element manipulation and/or organization in a multiple input computing system may be improved. It will be appreciated that the above method may be represented as instructions on computer-readable media, the instructions being executable by a processing subsystem to perform plural temporally overlapping drag and drop operations.

In one particular example, the computer-readable media may include instructions that, when executed by a processing subsystem: bind the first source to a first input received by the user interface; identify a potential target of the first source; during a duration in which the first source remains bound to the first input, bind the second source to a second input received by the user interface; identify a potential target of the second source; receive a request from the potential target of the first source to claim the first source; release the first source to the potential target of the first source; receive a request from the potential target of the second source to claim the second source; and release the second source to the potential target of the second source.

In one example, the instruction may be executable at a computing system having multiple user input devices and the first input may be controlled by a first user input device and the second input may be controlled by a second user input device, and the first input may be controlled independent of the second input and the second input may be controlled independent of the first input.

Furthermore, the instructions may define, or work in conjunction with, an application programming interface (API) by which requests from other computing objects and/or applications may be received and responses may be returned to the computing objects and/or applications. For example, the method may be used to perform drag and drop operations between different applications programs.

It will be appreciated that the configurations and/or approaches described herein are exemplary in nature, and that these specific embodiments or examples are not to be considered in a limiting sense, because numerous variations are possible. Furthermore, the specific process flows or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the exemplary embodiments described herein, but are provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-touch computing system, comprising:
a display subsystem configured to present a first source, a second source, and one or more targets on a surface of the display subsystem, the display system further configured to detect at least one touch input contacting the surface of the display subsystem;
a processing subsystem operatively connected to the display subsystem; and
computer-readable media operatively connected to the processing subsystem and including instructions that, when executed by the processing subsystem:
bind the first source to a first touch input;
identify a potential target of the first source;
during a duration in which the first source remains bound to the first touch input, bind the second source to a second touch input;
identify a potential target of the second source;
receive a request from the potential target of the first source to claim the first source;
release the first source to the potential target of the first source;
receive a request from the potential target of the second source to claim the second source; and
release the second source to the potential target of the second source.

2. The multi-touch computing system of claim 1, wherein the display subsystem comprises:
an image generation subsystem positioned to project the first source, the second source, and one or more targets onto the surface of the display subsystem;
a reference light source positioned to direct reference light at the surface of the display subsystem so that a pattern of reflection of the reference light changes responsive to touch input on the surface of the display subsystem; and
a sensor to detect the pattern of reflection, wherein the processing subsystem is operatively connected to the image generation subsystem and the sensor.

3. The multi-touch computing system of claim 2, wherein during the duration in which the first source remains bound to the first touch input and the second source is bound to the second touch input, the first touch input controls a position or orientation of the first source independent of the second touch input and the second touch input controls a position or orientation of the second source independent of the first touch input.

4. The multi-touch computing system of claim 2, wherein the computer-readable media further includes instructions, that when executed by the processing subsystem:
cause the image generation subsystem to display a cursor that tracks touch input.

5. The multi-touch computing system of claim 4, wherein the cursor includes a visual representation of the bound source.

6. The multi-touch computing system of claim 4, wherein an orientation of the cursor changes based on positional changes of the touch input.

7. The multi-touch computing system of claim 2, wherein identifying a potential target includes identifying plural possible targets based on a property of the plural possible targets.

8. The multi-touch computing system of claim 1, wherein a source is claimed by a target in response to a successful hit test at the target.

9. The multi-touch computing system of claim 8, wherein the source is released to the target responsive to conclusion of touch input at the source.

10. The multi-touch computing system of claim 8, wherein a successful hit test includes an intersection of a bound source and the target performing the hit test.

11. The multi-touch computing system of claim 8, wherein the successful hit test includes an intersection of a touch input to which a source is bound and the target performing the hit test.

12. The multi-touch computing system of claim 1, wherein the potential target of the first source is the potential target of the second source.

13. A method of performing an independent secondary computing operation during a primary drag and drop operation, the method comprising:
initiating the primary drag and drop operation by binding a source to an input;
identifying a potential target of the source;
during a duration in which the source remains bound to the input, initiating the independent secondary computing operation without interrupting the primary drag and drop operation;
receiving a request from the potential target of the source to claim the source;
releasing the source to the potential target of the source; and
completing the independent secondary computing operation.

14. The method of claim 13, wherein a plurality of requests are received to claim the source and the source is released to a requesting target based on a distance to the source.

15. The method of claim 13, wherein the input includes a touch input.

16. The method of claim 13, wherein the input includes a peripheral input.

17. Computer-readable media including instructions that, when executed by a processing subsystem:
bind the first source to a first input;
identify a potential target of the first source;
during a duration in which the first source remains bound to the first input, bind the second source to a second input;
identify a potential target of the second source;
receive a request from the potential target of the first source to claim the first source;
release the first source to the potential target of the first source;
receive a request from the potential target of the second source to claim the second source; and
release the second source to the potential target of the second source.

18. The computer-readable media of claim 17, wherein the second source is the potential target of the first source.

19. The computer-readable media of claim 17, wherein the potential target of the first source is the potential target of the second source.

20. The computer-readable media of claim 17, wherein the first input is controlled by a first user input device and the second input is controlled by a second user input device, the first input being controlled independent of the second input.
